(19) United States
(12) Patent Application Publication
(10) Pub. No.: US 2015/0212605 A1
(43) Pub. Date: Jul. 30, 2015

(54) ACTIVE CAPACITIVE TOUCH PEN FOR PROVIDING AN ADJUSTABLE ELECTROMAGNETIC FIELD

(71) Applicant: WALTOP INTERNATIONAL CORPORATION, Hsinchu County (TW)

(72) Inventor: CHIEN-CHIA LIEN, Miaoli County (TW)

(73) Assignee: WALTOP INTERNATIONAL CORPORATION, Hsinchu County (TW)

(21) Appl. No.: 14/244,617

(22) Filed: Apr. 3, 2014

(30) Foreign Application Priority Data
Jan. 29, 2014 (TW) 103103490

(51) Int. Cl. G06F 3/0354

(52) U.S. Cl. CPC G06F 3/03545

(57) ABSTRACT

An active capacitive touch pen includes a casing unit, a circuit unit, a power supply unit, a pen core unit and an electromagnetic unit. The casing unit includes a pen-shaped casing structure. The circuit unit includes a circuit substrate disposed inside the pen-shaped casing structure and electrically connected to the power supply unit. The pen core unit includes a pen core structure movably disposed inside the pen-shaped casing structure and electrically connected to the circuit substrate, and one part of the pen core structure is exposed outside the pen-shaped casing structure. The electromagnetic unit includes a fixed magnetic structure fixed inside the pen-shaped casing structure and disposed around the pen core structure and a movable magnetic structure fixedly disposed around the pen core structure and electrically connected to the circuit substrate. The movable magnetic structure is separated from the fixed magnetic structure by a predetermined adjustable distance.

### BACKGROUND OF THE INVENTION

1. Field of the Invention

The instant disclosure relates to an active capacitive touch pen, and more particularly to an active capacitive touch pen for providing an adjustable electromagnetic field.

2. Description of Related Art

Conventional touch control devices may be classified into three types: resistive, electromagnetic and capacitive. Operation with a resistive touch control device requires a rigid pen tip to apply a significant force on the resistive touch control device in a very small area to accomplish deformation of the resistive touch sensor, and an electromagnetic touch control device requires a special battery powered pen for input; while the working principle of a capacitive touch control device relies on capacitive coupling, which takes place as soon as the capacitive touch sensor is touched by a conductive object, and the touch position can then be identified according to the variation in capacitance at the touch point. Therefore, a capacitive touch control device does not require an input pen that consumes electricity. Nor is it necessary to subject a capacitive touch sensor to concentrated pressure application for deformation, and thus a capacitive touch control device has a longer service life. Furthermore, mass production of capacitive touch control devices requires lower costs due to its simple construction, less components and higher yield rate.

A capacitive touch control device can be operated in many ways. The most common of all is using a conductor, for example a finger or a pen, to touch or slide on the surface of the capacitive touch control device, for the capacitive touch sensor thereof to generate a response signal. However, as capacitive touch control devices find more and more applications, the lower precision on position detection tends to hinder smoothness of operation where more precise and more efficient detection is required, such as in handheld devices. In order to enable enhanced precision on position detection, many people choose to use pens for capacitive touch input.

### SUMMARY OF THE INVENTION

One aspect of the instant disclosure relates to an active capacitive touch pen for providing an adjustable electromagnetic field.

One of the embodiments of the instant disclosure provides an active capacitive touch pen for providing an adjustable electromagnetic field, comprising: a casing unit, a circuit unit, a power supply unit, a pen core unit and an electromagnetic unit. The casing unit includes a pen-shaped casing structure. The circuit unit includes a circuit substrate disposed inside the pen-shaped casing structure, wherein one part of the pen-shaped casing structure is electrically connected to the circuit substrate. The power supply unit includes at least one power supply element disposed inside the pen-shaped casing structure and electrically connected to the circuit substrate. The pen core unit includes a pen core structure movably disposed inside the pen-shaped casing structure and electrically connected to the circuit substrate, wherein one part of the pen core structure is exposed outside the pen-shaped casing structure. The electromagnetic unit includes a fixed magnetic structure fixed inside the pen-shaped casing structure and disposed around the pen core structure and a movable magnetic structure fixedly disposed around the pen core structure and electrically connected to the circuit substrate, wherein the movable magnetic structure is adjacent to the fixed magnetic structure and separated from the fixed magnetic structure by a predetermined adjustable distance.

More precisely, the pen-shaped casing structure includes a hollow plastic outer tube, a hollow metal outer tube and a pen tail cover, one lateral side of the hollow metal outer tube and one lateral side of the hollow plastic outer tube are mated with each other, and another lateral side of the hollow metal outer tube and the pen tail cover are mated with each other, wherein the hollow plastic outer tube has at least one retaining hole covered by the hollow metal outer tube, and one part of the pen core structure is exposed outside another lateral side of the hollow plastic outer tube.

More precisely, the active capacitive touch pen further comprises: a support unit including a support structure disposed inside the pen-shaped casing structure for supporting the circuit unit, the pen core unit and the electromagnetic unit, wherein the support structure has a cable arrangement groove disposed on the outer surface thereof, and the support structure has a retaining element retained in the retaining hole of the hollow plastic outer tube; a first conductive unit including at least one first conductive element disposed on the circuit substrate and electrically connected between the circuit substrate and the hollow metal outer tube; a second conductive unit including at least one second conductive element disposed between pen core structure and the circuit substrate and electrically connected between pen core structure and the circuit substrate; and an elastic unit including at least one elastic element disposed around the pen core structure and abutted against the support structure.

More precisely, the pen core structure includes a metal pen core passing through the fixed magnetic structure and the movable magnetic structure, a metal pen head connected to a first end portion of the metal pen core, and a plastic protection film covering a first end portion of the metal pen head and partially exposed outside the hollow plastic outer tube, wherein the metal pen core is electrically connected to the circuit substrate through the at least one second conductive element, the metal pen core has a surrounding position limiting portion surroundingly disposed on the metal pen core, and the at least one elastic element is surroundingly disposed on the metal pen core and connected between the surrounding position limiting portion and the support structure.

More precisely, the fixed magnetic structure is fixed inside the support structure, and the metal pen core movably passes through the fixed magnetic structure, wherein the movable magnetic structure includes a hollow electromagnetic body fixedly disposed around the metal pen core and an electromagnetic coil wound around the hollow electromagnetic body and electrically connected to the circuit substrate, and the electromagnetic coil has two extending portions pass through and disposed outside the support structure and extended along the cable arrangement groove.

Another one of the embodiments of the instant disclosure provides an active capacitive touch pen for providing an adjustable electromagnetic field, comprising: a casing unit, a circuit unit, a power supply unit, a pen core unit and an electromagnetic unit. The casing unit includes a pen-shaped casing structure, wherein the pen-shaped casing structure includes a hollow plastic outer tube and a hollow metal outer tube connected to the hollow plastic outer tube. The circuit unit includes a circuit substrate disposed inside the pen-shaped casing structure, wherein the hollow metal outer tube of the pen-shaped casing structure is electrically connected to the circuit substrate. The power supply unit includes at least one power supply element disposed inside the pen-shaped casing structure and electrically connected to the circuit substrate. The pen core unit includes a pen core structure movably disposed inside the pen-shaped casing structure and electrically connected to the circuit substrate, wherein one part of the pen core structure is exposed outside the hollow plastic outer tube of the pen-shaped casing structure. The electromagnetic unit includes a movable magnetic structure fixedly disposed around the pen core structure and electrically connected to the circuit substrate.

Yet another one of the embodiments of the instant disclosure provides an active capacitive touch pen for providing an adjustable electromagnetic field, comprising: a casing unit including a pen-shaped casing structure, wherein the pen-shaped casing structure includes a hollow metal outer tube; a circuit unit including a circuit substrate disposed inside the pen-shaped casing structure, wherein the hollow metal outer tube of the pen-shaped casing structure is electrically connected to the circuit substrate; a power supply unit including at least one power supply element disposed inside the pen-shaped casing structure and electrically connected to the circuit substrate; a first conductive unit including at least one first conductive element disposed on the circuit substrate and electrically connected between the circuit substrate and the hollow metal outer tube; a pen core unit including a pen core structure movably disposed inside the pen-shaped casing structure and electrically connected to the circuit substrate, wherein one part of the pen core structure is exposed outside the pen-shaped casing structure; a second conductive unit including at least one second conductive element disposed between pen core structure and the circuit substrate and electrically connected between pen core structure and the circuit substrate; an electromagnetic unit including a movable magnetic structure fixedly disposed around the pen core structure and electrically connected to the circuit substrate; a support unit including a support structure disposed inside the pen-shaped casing structure for supporting the circuit unit, the pen core unit and the electromagnetic unit; and an elastic unit including at least one elastic element disposed around the pen core structure and abutted against the support structure.

Therefore, after the hollow plastic outer tube and the hollow metal outer tube are mated with each other, the hollow metal outer tube of the pen-shaped casing structure can be electrically connected to the circuit substrate through the first conductive unit. Hence, the metal pen head, the metal pen core, the second conductive element, the circuit substrate, the first conductive element and the hollow metal outer tube are electrically connected with each other in sequence, thus the active capacitive touch pen can provide a capacitive touch function for user. In addition, when a user uses the active capacitive touch pen on a capacitive touch panel having a built-in electromagnetic induction layer, the pen core structure can press the elastic element through the surrounding position limiting portion for adjusting the predetermined adjustable distance between the movable magnetic structure and the fixed magnetic structure, thus the electromagnetic field between the movable magnetic structure and the fixed magnetic structure are adjustable. Hence, the predetermined adjustable distance between the movable magnetic structure and the fixed magnetic structure can be used to determine the degree of pressure when the user uses the active capacitive touch pen on a capacitive touch panel having a built-in electromagnetic induction layer, thus the active capacitive touch pen can show lines on the capacitive touch panel, and the lines may have different thickness according to the degree of pressure.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a perspective, exploded, schematic view of the active capacitive touch pen according to the instant disclosure;

FIG. 2 shows a perspective, assembled, schematic view of the active capacitive touch pen according to the instant disclosure;

FIG. 3 shows a cross-sectional view taken along the section line A-A of FIG. 2;

FIG. 4 shows a cross-sectional view taken along the section line B-B of FIG. 2;

FIG. 5 shows an enlarged view taken on part A of FIG. 3;

FIG. 6 shows an enlarged view taken on part B of FIG. 3;

FIG. 7 shows an enlarged view taken on part C of FIG. 4;

FIG. 8 shows an enlarged view taken on part D of FIG. 4; and

FIG. 9 shows a partial, assembled, schematic view of the active capacitive touch pen according to the instant disclosure.

### DETAILED DESCRIPTION OF THE PREFERRED EMBODIMENTS

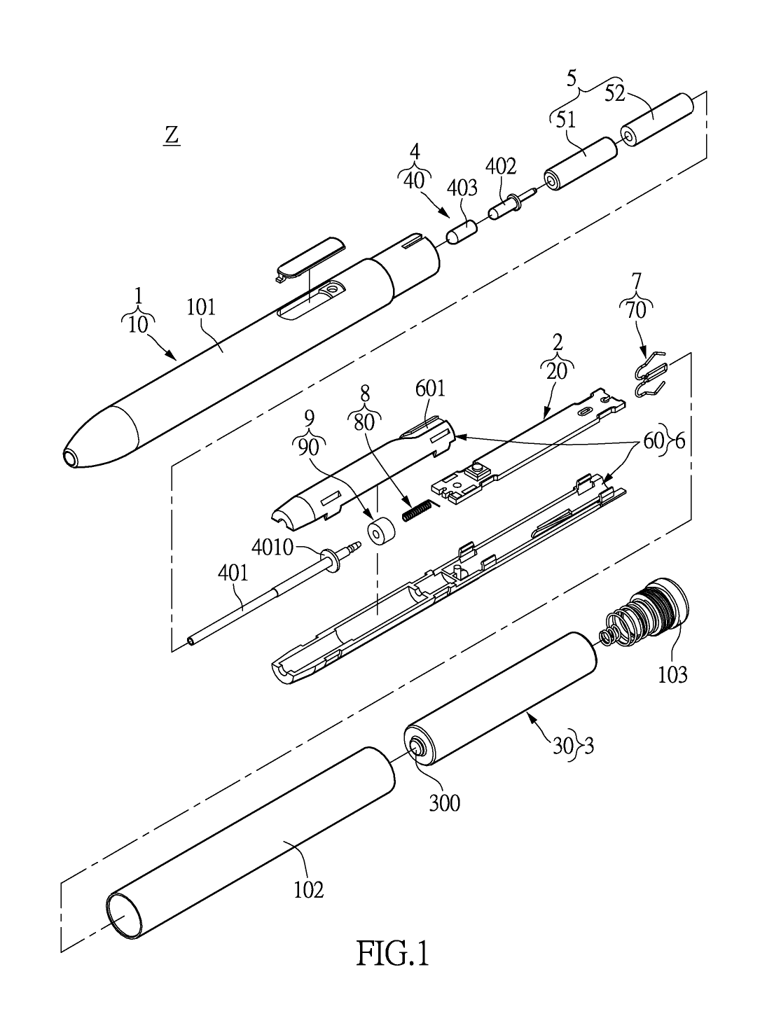

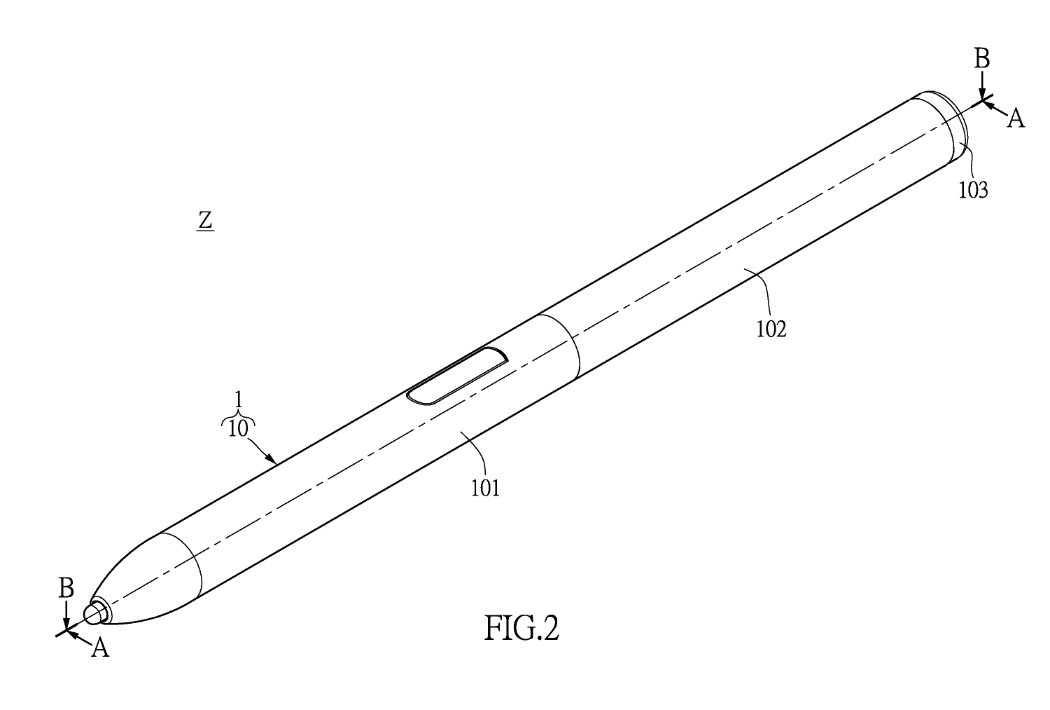

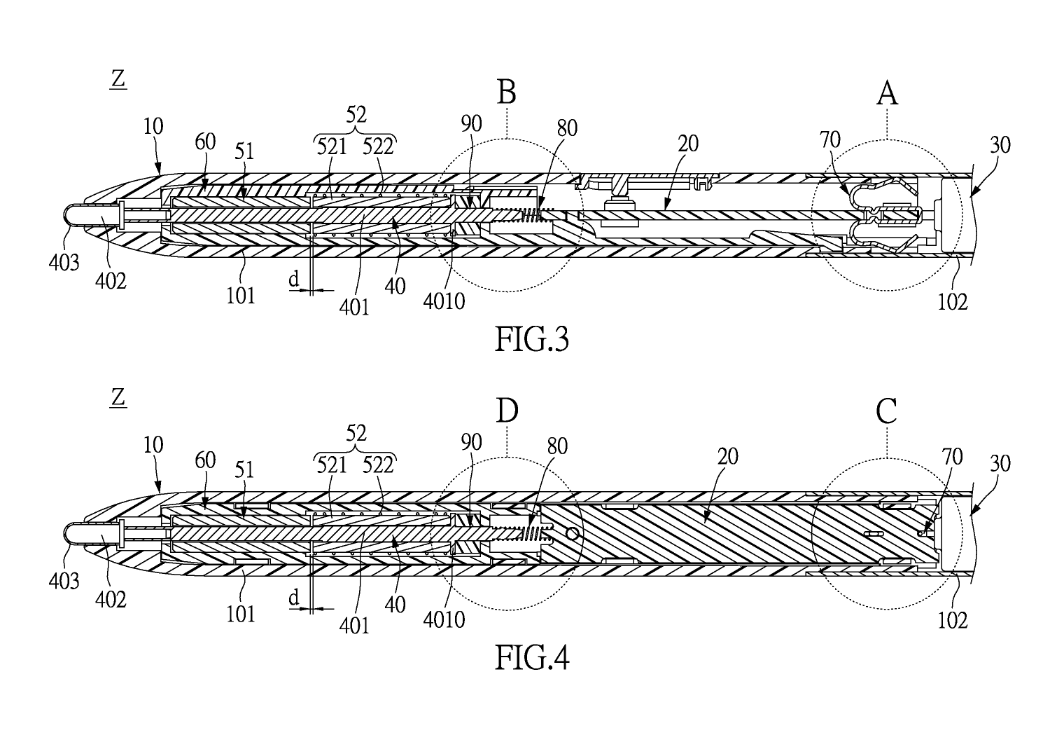

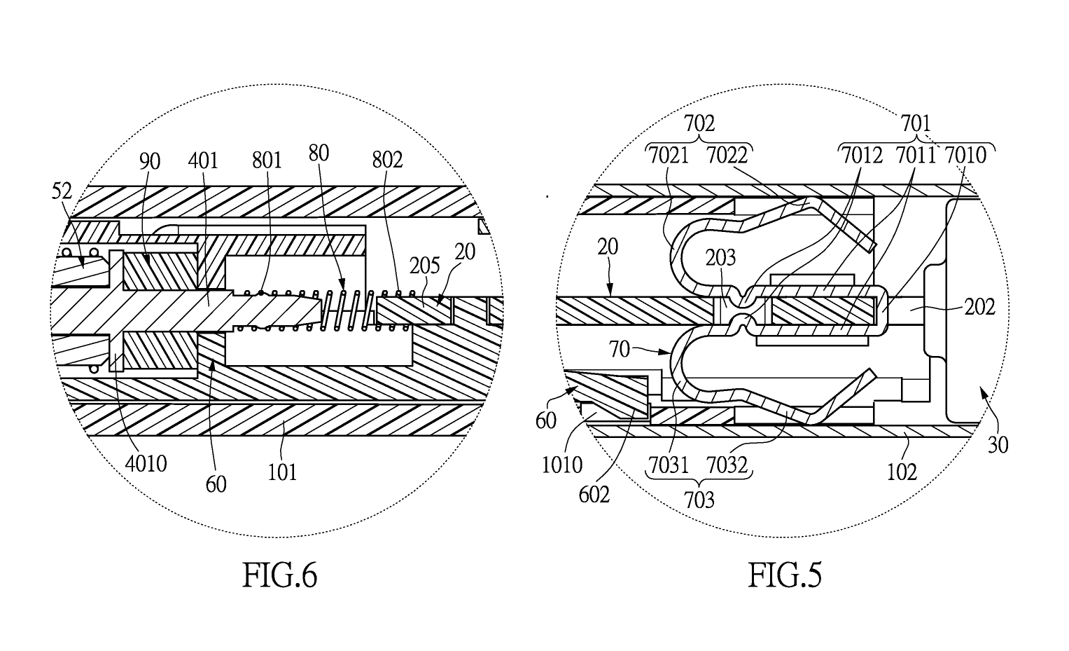

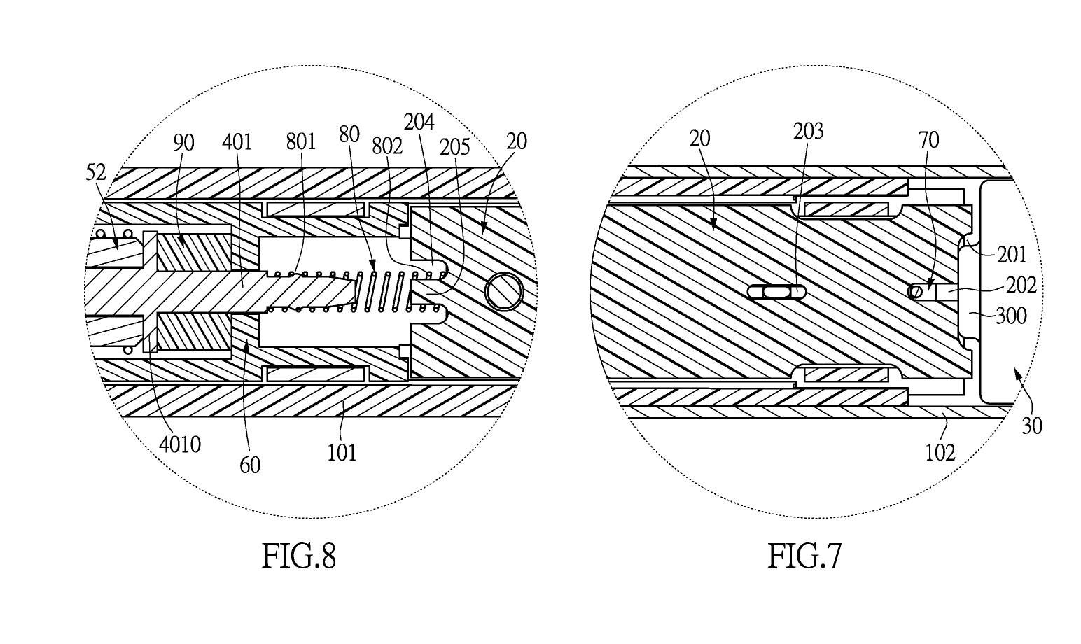

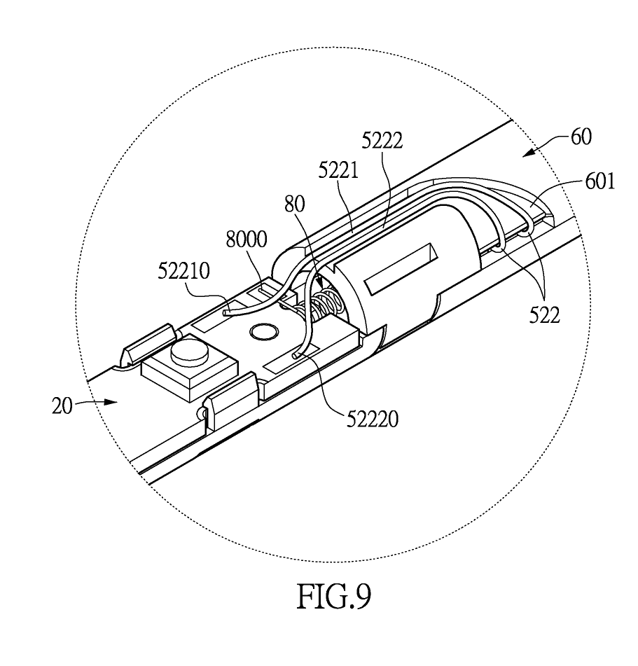

FIG. 1 is a perspective, exploded, schematic diagram, FIG. 2 is a perspective, assembled, schematic diagram, FIG. 3 shows a cross-sectional view taken along the section line A-A of FIG. 2, FIG. 4 shows a cross-sectional view taken along the section line B-B of FIG. 2, FIG. 5 shows an enlarged view taken on part A of FIG. 3, FIG. 6 shows an enlarged view taken on part B of FIG. 3, FIG. 7 shows an enlarged view taken on part C of FIG. 4, FIG. 8 shows an enlarged view taken on part D of FIG. 4, and FIG. 9 is a partial, assembled, schematic diagram. Referring to FIG. 1 to FIG. 9, the instant disclosure provides an active capacitive touch pen Z for providing an adjustable electromagnetic field, comprising: a casing unit 1, a circuit unit 2, a power supply unit 3, a pen core unit 4 and an electromagnetic unit 5.

First, referring to FIG. 1, FIG. 3 and FIG. 4, the casing unit 1 includes a pen-shaped casing structure 10. The circuit unit 2 includes a circuit substrate 20 disposed inside the pen-shaped casing structure 10, and one part of the pen-shaped casing structure 10 is electrically connected to the circuit substrate 20. The power supply unit 3 includes at least one power supply element 30 disposed inside the pen-shaped casing structure 10 and electrically connected to the circuit substrate 20. The pen core unit 4 includes a pen core structure 40 movably disposed inside the pen-shaped casing structure 10 and electrically connected to the circuit substrate 20, and one part of the pen core structure 40 is exposed outside the pen-shaped casing structure 10. The electromagnetic unit 5 includes a fixed magnetic structure 51 fixed inside the pen-shaped casing structure 10 and disposed around the pen core structure 40 and a movable magnetic structure 52 fixedly disposed around the pen core structure 40 and electrically connected to the circuit substrate 20, and the movable magnetic structure 52 is adjacent to the fixed magnetic structure 51 and separated from the fixed magnetic structure 51 by a predetermined adjustable distance d (as shown in FIG. 3 or FIG. 4).

Moreover, referring to FIG. 1, FIG. 2, FIG. 3 and FIG. 4, the pen-shaped casing structure 10 includes a hollow plastic outer tube 101, a hollow metal outer tube 102 and a pen tail cover 103. One lateral side of the hollow metal outer tube 102 and one lateral side of the hollow plastic outer tube 101 are mated with each other, and another lateral side of the hollow metal outer tube 102 and the pen tail cover 103 are mated with each other, and one part of the pen core structure 40 is exposed outside another lateral side of the hollow plastic outer tube 101. For example, the hollow metal outer tube 102 may be made of copper or any conductive material, but it is merely an example and is not meant to limit the instant disclosure.

Furthermore, referring to FIG. 5, FIG. 7 and FIG. 8, the circuit substrate 20 has a first lateral groove 201 disposed on a first lateral side of the circuit substrate 20, a first through hole 202 passing through the circuit substrate 20 and communicated with the first lateral groove 201, a second through hole 203 passing through the circuit substrate 20 and adjacent to the first through hole 202, a second lateral groove 204 disposed on a second lateral side of the circuit substrate 20, and a retaining block 205 disposed in the second lateral groove 204. In addition, referring to FIG. 4 and FIG. 8, the power supply element 30 has a positive electrode portion 300 disposed in the first lateral groove 201 to directly and electrically contact the circuit substrate 20. More precisely, a conductive layer (not shown) is formed on the inner surface of the first lateral groove 201 of the circuit substrate 20 in advance, thus when the positive electrode portion 300 of the power supply element 30 in inserted into the first lateral groove 201 to electrically contact the circuit substrate 20, the positive electrode portion 300 of the power supply element 30 is directly and electrically connected to the circuit substrate 20 without any conductive medium.

In addition, referring to FIG. 1, FIG. 3 and FIG. 4, the active capacitive touch pen Z further comprises a support unit 6, a first conductive unit 7, a second conductive unit 8 and an elastic unit 9. The support unit 6 includes a support structure 60 disposed inside the pen-shaped casing structure 10 for supporting or carrying the circuit unit 2, the pen core unit 4 and the electromagnetic unit 5. The first conductive unit 7 includes at least one first conductive element 70 disposed on the circuit substrate 20 and electrically connected between the circuit substrate 20 and the hollow metal outer tube 102. The second conductive unit 8 includes at least one second conductive element 80 disposed between pen core structure 40 and the circuit substrate 20 and electrically connected between pen core structure 40 and the circuit substrate 20. The elastic unit 9 includes at least one elastic element 90 disposed around the pen core structure 40 and abutted against the support structure 60.

More precisely, referring to FIG. 1, FIG. 3 and FIG. 4, the pen core structure 40 includes a metal pen core 401 passing through the fixed magnetic structure 51 and the movable magnetic structure 52, a metal pen head 402 connected to a first end portion of the metal pen core 401, and a plastic protection film 403 covering a first end portion of the metal pen head 402 and partially exposed outside the hollow plastic outer tube 101. In addition, the metal pen core 401 is electrically connected to the circuit substrate 20 through the second conductive element 80, and the metal pen core 401 has a surrounding position limiting portion 4010 surroundingly and integrally disposed on the outer surface of the metal pen core 401.

More precisely, referring to FIG. 1, FIG. 3 and FIG. 4, the fixed magnetic structure 51 (such as a hollow iron core) is fixed inside the support structure 60, and the metal pen core 401 movably passes through the fixed magnetic structure 51. The movable magnetic structure 52 includes a hollow electromagnetic body 521 (such as a hollow iron core) fixedly disposed around the metal pen core 401 and connected to the surrounding position limiting portion 4010 and an electromagnetic coil 522 wound around the hollow electromagnetic body 521 and electrically connected to the circuit substrate 20.

More precisely, referring to FIG. 3 and FIG. 5, the first conductive element 70 has an elastic retaining portion 701 retained on the circuit substrate 20, a first elastic extending portion 702 upwardly extended from the elastic retaining portion 701 to abut against and electrically connected to the inner surface of the hollow metal outer tube 102, and a second elastic extending portion 703 downwardly extended from the elastic retaining portion 701 to abut against and electrically connected to the inner surface of the hollow metal outer tube 102. Whereby, after the hollow plastic outer tube 101 and the hollow metal outer tube 102 are mated with each other, the hollow metal outer tube 102 of the pen-shaped casing structure 10 can be electrically connected to the circuit substrate 20 through the first conductive unit 7. Hence, the metal pen head 402, the metal pen core 401, the second conductive element 80, the circuit substrate 20, the first conductive element 70 and the hollow metal outer tube 102 are electrically connected with each other in sequence, thus the active capacitive touch pen Z can provide a capacitive touch function for user.

For example, referring to FIG. 5 and FIG. 7, the elastic retaining portion 701 has a passing section 7010 passing through the first through hole 202, two extension sections 7011 respectively extended from two opposite ends of the passing section 7010 and along the circuit substrate 20, and two insertion sections 7012 respectively extended from two extension sections 2011 and inserted into the second through hole 203. In addition, the first elastic extending portion 702 has a first front extension section 7021 forwardly extended from a first end of the elastic retaining portion 701 and an upward extension section 7022 upwardly extended from the first front extension section 7021 to abut against and electrically connected to the inner surface of the hollow metal outer tube 102, and the second elastic extending portion 703 has a second front extension section 7031 forwardly extended from a second end of the elastic retaining portion 701 and an downward extension section 7032 downwardly extended from the second front extension section 7031 to abut against and electrically connected to the inner surface of the hollow metal outer tube 102.

More precisely, referring to FIG. 6 and FIG. 8, the second conductive element 80 (such as a compression spring or an elastic piece) has a first end portion 801 disposed around the second end portion of the metal pen core 401 and a second end portion 802 disposed around the retaining block 205 to electrically contact the circuit substrate 20, and the elastic element 90 (such as a rubber or a compression spring) is surroundingly disposed on the metal pen core 401 and connected between the surrounding position limiting portion 4010 and the support structure 60.

Therefore, when a user uses the active capacitive touch pen Z on a capacitive touch panel (not shown) having a built-in electromagnetic induction layer, the pen core structure 40 can press the elastic element 90 through the surrounding position limiting portion 4010 for adjusting the predetermined adjustable distance d between the movable magnetic structure 52 and the fixed magnetic structure 51, thus the electromagnetic field between the movable magnetic structure 52 and the fixed magnetic structure 51 are adjustable. Hence, the predetermined adjustable distance d between the movable magnetic structure 52 and the fixed magnetic structure 51 can be used to determine the degree of pressure when the user uses the active capacitive touch pen Z on a capacitive touch panel (not shown) having a built-in electromagnetic induction layer, thus the active capacitive touch pen Z can show lines on the capacitive touch panel, and the lines may have different thickness according to the degree of pressure.

It is worth mentioning that referring to FIG. 3 and FIG. 5, the hollow plastic outer tube 101 has at least one retaining hole 1010, and the support structure 60 has a retaining element 602 retained in the retaining hole 1010 of the hollow plastic outer tube 101. In other words, when the support structure 60 is inserted into the hollow plastic outer tube 101, the retaining element 602 of the support structure 60 is smoothly retained in the retaining hole 1010 of the hollow plastic outer tube 101, for firmly positioning the support structure 60 inside the hollow plastic outer tube 101. In addition, after the hollow plastic outer tube 101 and the hollow metal outer tube 102 are mated with each other, the retaining hole 1010 is covered by the hollow metal outer tube 102. Moreover, referring to FIG. 1 and FIG. 9, the support structure 60 has a cable arrangement groove 601 disposed on the outer surface of the support structure 60, and the electromagnetic coil 522 has two extending portions (a first extending portion 5221 and a second extending portion 5222) pass through and disposed outside the support structure 60 and extended along the cable arrangement groove 601. In addition, the first extending portion 5221 has a first end 52210 soldered on the circuit substrate 20, and the second extending portion 5222 has a second end 52220 soldered on the circuit substrate 20. The second conductive element 80 has an end 8000 electrically contact the circuit substrate 20, thus the metal pen core 401 can be electrically connected to the circuit substrate 20 through the second conductive element 80.

In conclusion, after the hollow plastic outer tube 101 and the hollow metal outer tube 102 are mated with each other, the hollow metal outer tube 102 of the pen-shaped casing structure 10 can be electrically connected to the circuit substrate 20 through the first conductive unit 7. Hence, the metal pen head 402, the metal pen core 401, the second conductive element 80, the circuit substrate 20, the first conductive element 70 and the hollow metal outer tube 102 are electrically connected with each other in sequence, thus the active capacitive touch pen Z can provide a capacitive touch function for user. In addition, when a user uses the active capacitive touch pen Z on a capacitive touch panel (not shown) having a built-in electromagnetic induction layer, the pen core structure 40 can press the elastic element 90 through the surrounding position limiting portion 4010 for adjusting the predetermined adjustable distance d between the movable magnetic structure 52 and the fixed magnetic structure 51, thus the electromagnetic field between the movable magnetic structure 52 and the fixed magnetic structure 51 are adjustable. Hence, the predetermined adjustable distance d between the movable magnetic structure 52 and the fixed magnetic structure 51 can be used to determine the degree of pressure when the user uses the active capacitive touch pen Z on a capacitive touch panel (not shown) having a built-in electromagnetic induction layer, thus the active capacitive touch pen Z can show lines on the capacitive touch panel, and the lines may have different thickness according to the degree of pressure.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. An active capacitive touch pen for providing an adjustable electromagnetic field, comprising:
a casing unit including a pen-shaped casing structure;
a circuit unit including a circuit substrate disposed inside the pen-shaped casing structure, wherein one part of the pen-shaped casing structure is electrically connected to the circuit substrate;
a power supply unit including at least one power supply element disposed inside the pen-shaped casing structure and electrically connected to the circuit substrate;
a pen core unit including a pen core structure movably disposed inside the pen-shaped casing structure and electrically connected to the circuit substrate, wherein one part of the pen core structure is exposed outside the pen-shaped casing structure; and
an electromagnetic unit including a fixed magnetic structure fixed inside the pen-shaped casing structure and disposed around the pen core structure and a movable magnetic structure fixedly disposed around the pen core structure and electrically connected to the circuit substrate, wherein the movable magnetic structure is adjacent to the fixed magnetic structure and separated from the fixed magnetic structure by a predetermined adjustable distance.

2. The active capacitive touch pen of claim 1, wherein the pen-shaped casing structure includes a hollow plastic outer tube, a hollow metal outer tube and a pen tail cover, one lateral side of the hollow metal outer tube and one lateral side of the hollow plastic outer tube are mated with each other, and another lateral side of the hollow metal outer tube and the pen tail cover are mated with each other, wherein the hollow plastic outer tube has at least one retaining hole covered by the hollow metal outer tube, and one part of the pen core structure is exposed outside another lateral side of the hollow plastic outer tube.

3. The active capacitive touch pen of claim 2, further comprising:
a support unit including a support structure disposed inside the pen-shaped casing structure for supporting the circuit unit, the pen core unit and the electromagnetic unit, wherein the support structure has a cable arrangement groove disposed on the outer surface thereof, and the support structure has a retaining element retained in the retaining hole of the hollow plastic outer tube;
a first conductive unit including at least one first conductive element disposed on the circuit substrate and electrically connected between the circuit substrate and the hollow metal outer tube;
a second conductive unit including at least one second conductive element disposed between pen core structure and the circuit substrate and electrically connected between pen core structure and the circuit substrate; and
an elastic unit including at least one elastic element disposed around the pen core structure and abutted against the support structure.

4. The active capacitive touch pen of claim 3, wherein the pen core structure includes a metal pen core passing through the fixed magnetic structure and the movable magnetic structure, a metal pen head connected to a first end portion of the metal pen core, and a plastic protection film covering a first end portion of the metal pen head and partially exposed outside the hollow plastic outer tube, wherein the metal pen core is electrically connected to the circuit substrate through the at least one second conductive element, the metal pen core has a surrounding position limiting portion surroundingly disposed on the metal pen core, and the at least one elastic element is surroundingly disposed on the metal pen core and connected between the surrounding position limiting portion and the support structure.

5. The active capacitive touch pen of claim 4, wherein the fixed magnetic structure is fixed inside the support structure, and the metal pen core movably passes through the fixed magnetic structure, wherein the movable magnetic structure includes a hollow electromagnetic body fixedly disposed around the metal pen core and an electromagnetic coil wound around the hollow electromagnetic body and electrically connected to the circuit substrate, and the electromagnetic coil has two extending portions pass through and disposed outside the support structure and extended along the cable arrangement groove.

6. The active capacitive touch pen of claim 4, wherein the circuit substrate has a first lateral groove disposed on a first lateral side thereof, a first through hole passing therethrough and communicated with the first lateral groove, a second through hole passing therethrough and adjacent to the first through hole, a second lateral groove disposed on a second lateral side thereof, and a retaining block disposed in the second lateral groove, wherein the at least one power supply element has a positive electrode portion disposed in the first lateral groove to electrically contact the circuit substrate, the at least one second conductive element has a first end portion disposed around the second end portion of the metal pen core and a second end portion disposed around the retaining block to electrically contact the circuit substrate.

7. The active capacitive touch pen of claim 6, wherein the at least one first conductive element has an elastic retaining portion retained on the circuit substrate, a first elastic extending portion upwardly extended from the elastic retaining portion to abut against the inner surface of the hollow metal outer tube, and a second elastic extending portion downwardly extended from the elastic retaining portion to abut against the inner surface of the hollow metal outer tube.

8. The active capacitive touch pen of claim 7, wherein the elastic retaining portion has a passing section passing through the first through hole, two extension sections respectively extended from two opposite ends of the passing section and along the circuit substrate, and two insertion sections respectively extended from two extension sections and inserted into the second through hole, the first elastic extending portion has a first front extension section forwardly extended from the elastic retaining portion and an upward extension section upwardly extended from the first front extension section to abut against the inner surface of the hollow metal outer tube, and the second elastic extending portion has a second front extension section forwardly extended from the elastic retaining portion and an downward extension section downwardly extended from the second front extension section to abut against the inner surface of the hollow metal outer tube.

9. An active capacitive touch pen for providing an adjustable electromagnetic field, comprising:
a casing unit including a pen-shaped casing structure, wherein the pen-shaped casing structure includes a hollow plastic outer tube and a hollow metal outer tube connected to the hollow plastic outer tube;
a circuit unit including a circuit substrate disposed inside the pen-shaped casing structure, wherein the hollow metal outer tube of the pen-shaped casing structure is electrically connected to the circuit substrate;
a power supply unit including at least one power supply element disposed inside the pen-shaped casing structure and electrically connected to the circuit substrate;
a pen core unit including a pen core structure movably disposed inside the pen-shaped casing structure and electrically connected to the circuit substrate, wherein one part of the pen core structure is exposed outside the hollow plastic outer tube of the pen-shaped casing structure; and
an electromagnetic unit including a movable magnetic structure fixedly disposed around the pen core structure and electrically connected to the circuit substrate.

10. An active capacitive touch pen for providing an adjustable electromagnetic field, comprising:
a casing unit including a pen-shaped casing structure, wherein the pen-shaped casing structure includes a hollow metal outer tube;
a circuit unit including a circuit substrate disposed inside the pen-shaped casing structure, wherein the hollow metal outer tube of the pen-shaped casing structure is electrically connected to the circuit substrate;
a power supply unit including at least one power supply element disposed inside the pen-shaped casing structure and electrically connected to the circuit substrate;
a first conductive unit including at least one first conductive element disposed on the circuit substrate and electrically connected between the circuit substrate and the hollow metal outer tube;
a pen core unit including a pen core structure movably disposed inside the pen-shaped casing structure and electrically connected to the circuit substrate, wherein one part of the pen core structure is exposed outside the pen-shaped casing structure;
a second conductive unit including at least one second conductive element disposed between pen core structure and the circuit substrate and electrically connected between pen core structure and the circuit substrate;
an electromagnetic unit including a movable magnetic structure fixedly disposed around the pen core structure and electrically connected to the circuit substrate;
a support unit including a support structure disposed inside the pen-shaped casing structure for supporting the circuit unit, the pen core unit and the electromagnetic unit; and
an elastic unit including at least one elastic element disposed around the pen core structure and abutted against the support structure.
